(19) United States
(12) Patent Application Publication
(10) Pub. No.: US 2007/0254202 A1
(43) Pub. Date: Nov. 1, 2007

(54) CATHODE FLOW FIELD BOARD FOR FUEL CELL

(76) Inventors: Hsi-Ming Shu, Taipei (TW); Tsang-Ming Chang, Taipei (TW); Chih-Jung Kao, Taipei (TW); Chun-Wei Pan, Taipei (TW); Wei-Li Huang, Taipei (TW)

Correspondence Address: G. LINK CO., LTD., 3550 BELL ROAD, MINOOKA, IL, 60447, US

(21) Appl. No.: 11/741,041

(22) Filed: Apr. 27, 2007

(30) Foreign Application Priority Data
May 1, 2006 (TW) 095207401

(51) Int. Cl. H01M 8/02; B32B 3/30

(52) U.S. Cl. 429/38; 428/167

(57) ABSTRACT

The present invention is a cathode flow field board for fuel cell, which comprises a substrate, an inlet channel structure configured on the substrate, at least one slot body, an outlet channel structure, a first hollow area, and a second hollow area; wherein, the inlet channel structure is connected between these slot bodies, and the inlet area of the inlet channel structure is a groove structure, and the area of the inlet channel structure connected to these slot bodies employs a hollow structure. The configured positions for the arrangement of these slot bodies are associated with these configured positions of cathodes for each membrane electrode assembly; the outlet channel structure is connected to these slot bodies; and, the first hollow area and the second hollow area are configured associating with the anode flow field board.

### FIELD OF THE INVENTION

The present invention relates to a flow field board for fuel cell, and particularly to a cathode flow field board, which has an extremely light overall weight, and low manufacturing cost, and provides the cathode fuel and cathode product with a fluid field environment for smoothly flowing.

### BACKGROUND OF THE INVENTION

The fuel cell is a generation device for directly transforming the chemical energy stored in fuel into electrical energy through the electrode reaction. There are numerous types of fuel cell, and with different categorization methods. If the fuel cells are categorized by the difference of electrolyte characteristics, there are five types of fuel cells with different electrolytes, such as alkaline fuel cell, phosphorous acid fuel cell, proton exchange membrane fuel cell, molten carbonate fuel cell, solid oxide fuel cell.

In the conventional fuel cell structure, the flow field board is placed at both sides of the membrane electrode assembly, and the used material should be provided with the features of high conductivity, high strength, easy to manufacture, light weight, and low cost. Currently, the material for making flow field board is graphite, aluminum, and stainless steel, and normally is made of graphite; and, machining channels on the flow field board as the channels for supplying fuel, so the reactant could reach the expansion layer through the channel, and enter the catalyst layer for joining the reaction. Moreover, the flow field board could have the function for conducting electric current, so the current generated from the reaction could be conducted and applied, and have the function as current collector board.

However, the conventional flow field board, such as graphite pallet, has a large volume, and the weight is not light enough. Therefore, the inventor of the present invention has been in view of the disadvantages of the conventional flow field board, and worked hard for improvement to invent a cathode flow field board.

### SUMMARY OF THE INVENTION

The main object of the present invention is to provide a cathode flow field board, which has an extremely light overall weight, and low manufacturing cost, and to provide the cathode fuel and cathode product with a fluid field environment for smoothly flowing.

The another object of the present invention is to provide a cathode flow field board with current collection function, which could not only greatly reduce the volume and weight of the fuel cell itself, but also improve the current collection function of the flow field board.

To this end, the present invention provides a cathode flow field board for fuel cell, which comprises a substrate, and an inlet channel structure configured on the substrate, at least one slot body, an outlet channel structure, a first hollow area and a second hollow area; wherein, the inlet channel structure is connected between these slot bodies, and the inlet area of the inlet channel structure is a groove structure, and the area of the inlet channel structure connected to these slot bodies employs a hollow structure; the configured positions for the arrangement of these slot bodies are associated with these configured positions of cathodes for each membrane electrode assembly; the outlet channel structure is connected to these slot bodies; and, the first hollow area and the second hollow area are configured associating with the anode flow field board.

### BRIEF DESCRIPTION OF DRAWINGS

The present invention would be detailed described in the following to make the skilled in the art understand the object, features and effects of the present invention through the following embodiments and the attached figures, wherein:

FIG. 1 is a three-dimensional diagram for a cathode flow field board for fuel cell of a preferred embodiment according to the present invention;

FIG. 2 is a three-dimensional diagram for a current collector sheet of a preferred embodiment according to the present invention;

FIG. 3 is a three-dimensional diagram for a cathode flow field board with current collector sheet of a preferred embodiment according to the present invention;

FIG. 4 is a three-dimensional diagram for a cathode flow field board configured with electric components of a preferred embodiment according to the present invention; and

FIG. 5 is a three-dimensional diagram of an anode flow field board associating with the cathode flow field board according to the present invention.

### DETAILED DESCRIPTION OF THE INVENTION

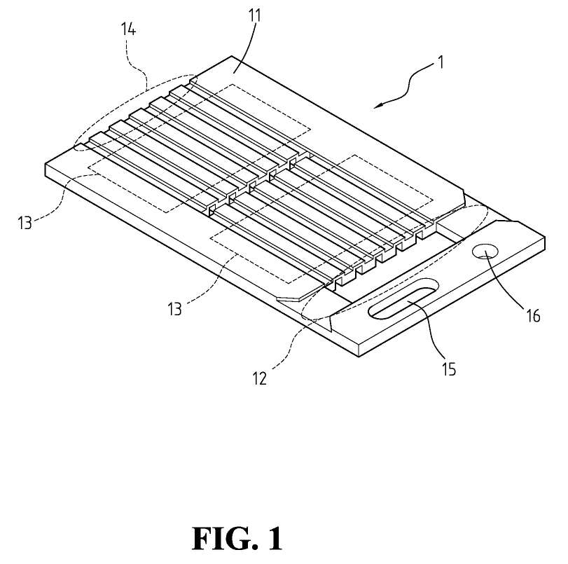

FIG. 1 is a three-dimensional diagram of a cathode flow field board for fuel cell of a preferred embodiment according to the present invention. The cathode flow field board 1 according to the present invention is applied to the fuel cell, in which the fuel cell is provided with at least one membrane electrode assembly. The cathode flow field board 1 according to the present invention comprises: a substrate 11, an inlet channel structure 12, at least one slot body 13, an outlet channel structure 14, a first hollow area 15, and a second hollow area 16, and these components will be detailed described in the followings.

The substrate 11 could be selected with one from anti-chemical non-conductive engineering plastic substrate, graphite substrate, metal substrate, plastic carbon substrate, FR4 substrate, FR5 substrate, epoxy resin substrate, glass-fiber substrate, ceramic substrate, polymer plasticized substrate, and composite material substrate. If the inlet channel structure 12, at least one slot body 13, the outlet channel structure 14, the first hollow area 15, and the second hollow area 16 are configured on the upper surface of substrate 11, they will form a one-sided cathode flow field board 1. On the other hand, if the inlet channel structure 12, at least one slot body 13, the outlet channel structure 14, the first hollow area 15, and the second hollow area 16 are configured both on the upper surface and the lower surface of the substrate 11, they will form a two-sided cathode flow field board 1.

The inlet channel structure 12 is configured on the substrate 11, and connected to at least one slot body 14. The inlet area of the inlet channel structure 12 is to dig the surface of the substrate 11 as a groove structure. And, the area of the inlet channel structure 12 connected to these slot bodies 13 employs a hollow structure, that is, the surface of the substrate 11 occupied by the connected areas are dug as hollow.

At least one slot body 13 are arranged and configured on the substrate 11, and each configured position of each slot body 13 is correspondingly associated with the configured position of the cathode for each membrane electrode assembly. The means for realizing these slot bodies 13 are dug from the surface of the substrate 11 to form a plurality of parallel slots.

The external cathode fuel, such as air, from the inlet channel structure 12 will flow into inside the cathode flow field board 1; then, the cathode fuel is introduced into each slot body 13; finally, flowing to the cathode of each membrane electrode assembly; furthermore, the cathode product, such as water, generated by the electrochemical reaction for the cathode of each membrane electrode assembly will flow into each slot body 13; and, the cathode product and the residual cathode fuel will flow to the outlet channel structure 14.

The outlet channel structure 14 is configured on the substrate 11, and connected to these slot bodies 13. The outlet channel structure 14 could employ a plurality of parallel slots, and these slots are connected to the slot bodies 13. The cathode product and the residual cathode fuel will flow through the outlet channel structure 14, and flow out to the external of the cathode flow field board 1.

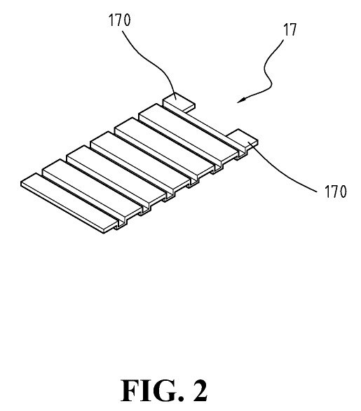

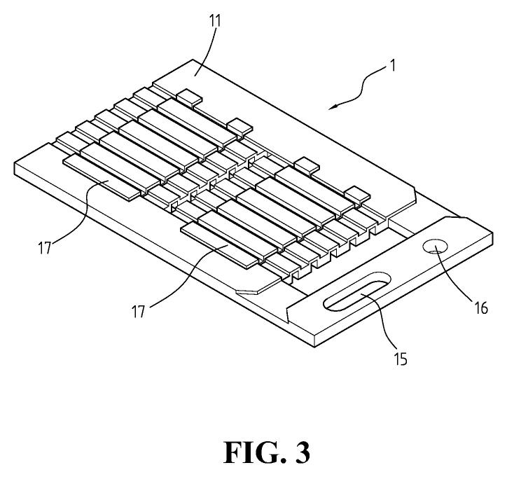

Furthermore, the present invention further comprises at least one current collector sheet 17. Please refer to FIG. 2 a three-dimensional diagram for an current collector sheet 17 of a preferred embodiment according to the present invention, and FIG. 3 a three-dimensional diagram for a cathode flow field board with current collector sheet of a preferred embodiment according to the present invention. The material for current collector sheet 17 is a conductive material, and as an anti-chemical material for anti-erosion and/or anti-acid, for example selecting one from stainless steel (SUS316) sheet, gold foil, titanium metal, graphite material, carbon metal compound material, metal alloy sheet, and polymer conductive sheet with low resistance. Each current collector sheet 17 is attached and fixed on each slot body 13. The current collector sheet 17 is provided with at least one flange 170, and these flanges 170 are protruded from the slot bodies 13. The concrete structure employed by the current collector sheet 17 is determined by the concrete structure of the slot body 13.

Moreover, a conductive sheet is further attached and sandwiched between each current collector sheet 17 and each slot body 13 (not shown). The conductive sheet could employ the high conductivity material, and could be chosen to use the spot-welding method, so as to bond these conductive sheet layers between these electricity collection sheets 17 and these slot bodies 13; or, with thermal press machine, employing a resin Prepreg or a bonding agent with anti-erosion and/or anti-acid function, such as AB glue, to press and bond these conductive sheets between these current collector sheets 17 and these slot bodies 13. Furthermore, it could choose to use the sputtering and spraying process to form a layer of thin metal layer on the bottom surface of the current collector sheet 17; or, forming a layer of thin metal layer on the upper surface of the slot body 13. The material for the conductive sheet and thin metal layer could be selected from one of gold, copper, silver, carbon, high conductivity metal.

The conductive sheet is provided with at least one flange, and these flanges are protruded from the slot bodies 13.

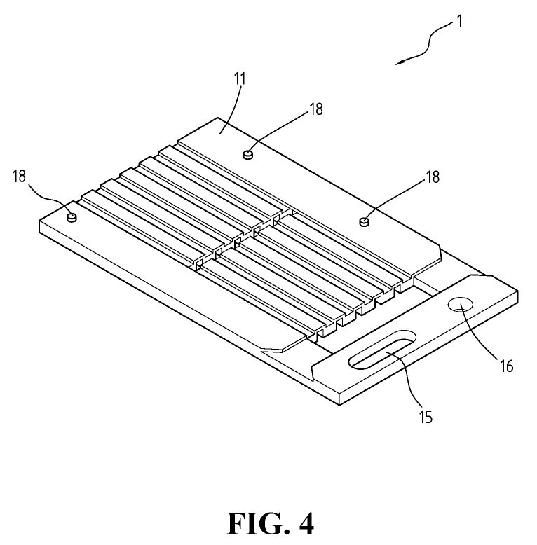

FIG. 4 is a three-dimensional diagram for a cathode flow field board configured with electric components of a preferred embodiment according to the present invention. The surface of the substrate 11 other than the area used by inlet channel structure 12, these slot bodies 13, outlet channel structure 14, the first hollow area 15, and the second hollow area 16 could be used to configure with the circuitry, for example employing printed circuitry, and coating with a layer of protection painting on the surface of printed circuitry, such as green paint. The printed circuitry is electrically connected to the flange of these current collector sheets 17; and, further selecting to configure at least one electric component 18 on the circuitry. The embodiments of these electric components 18 are, for example, temperature sensor, density sensor, liquid level sensor, heating device, and cooling device.

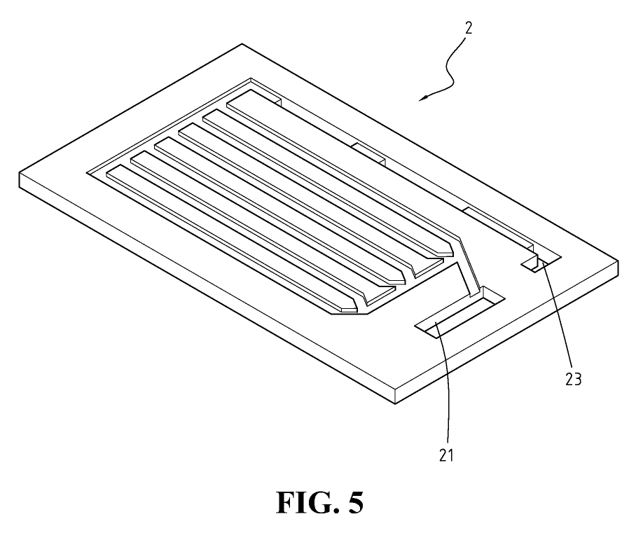

FIG. 5 is a three-dimensional diagram of an anode flow field board associating with the cathode flow field board according to the present invention. The first hollow area 15 and the second hollow area 16 are configured for the anode flow field board 2. The first hollow area 15 of the cathode flow field board 1 could be overlapped on the shunt portion 21 of the anode flow field board 2. Because the shunt portion 21 of the anode flow field board 2 employs a hollow structure, after the overlapping of the first hollow area 15 and the shunt portion 21, they could form a small inner space. The second hollow area 16 of the cathode flow field board 1 could be overlapped to the outlet hole 23 of the anode flow field board 2. Because the outlet hole 23 of the anode flow field board 2 employs a hollow structure, after the overlapping of the second hollow area 16 and the outlet hole 23, they could form another small inner space.

The cathode flow field board 1 according to the present invention could be applied in various types of fuel cells, such as the fuel cell using methanol fuel, or the fuel cell using liquid fuel, the fuel cell using gas fuel, and the fuel cell using solid fuel, etc.

The cathode flow field board according to the present invention could have an extremely light overall weight, and low manufacturing cost, and provide the cathode fuel and cathode product with a fluid field environment for smoothly flowing, which disclose the advantages, effects and improvements in the present invention.

The present invention has been described as above. Thus, the disclosed embodiments are not limiting the scope of the present invention. And, for the skilled in the art, it is well appreciated that the change and modification without departing from the claims of the present invention should be within the spirit and scope of the present invention, and the protection scope of the present invention should be defined with the attached claims.

What is claimed is:

1. A cathode flow field board for fuel cell, which comprises:
a substrate;
an inlet channel structure, configured on the substrate, which is connected to at least one slot body, in which the inlet area of the inlet channel structure is a groove structure, and the area of the inlet channel structure connected to the slot bodies employs a hollow structure;
the slot bodies, arranged and configured on the substrate, in which the configured position for each slot body is correspondingly associated with the configured position of the cathode for each membrane electrode assembly;
an outlet channel structure, configured on the substrate and connected to the slot bodies;
a first hollow area, configured on one side of the substrate, in which the first hollow area is to dig with a small area on the substrate as a hollow area; and,
a second hollow area, configured on one side of the substrate, in which the second hollow area is to dig with a small area on the substrate as a hollow area.

2. The cathode flow field board according to claim 1, further comprises: at least one current collector sheet, which is made of conductive material, and each current collector sheet is attached and fixed on each slot body.

3. The cathode flow field board according to claim 2, wherein the current collector sheet comprises at least one flange, which are protruded from the slot body.

4. The cathode flow field board according to claim 1, wherein the slot body is formed with a plurality of parallel slots.

5. The cathode flow field board according to claim 1, wherein the substrate is selected one from an anti-chemical non-conductor engineering plastic substrate, a graphite substrate, a metal substrate, a plastic carbon substrate, a FR4 substrate, a FR5 substrate, an epoxy resin substrate, a glass-fiber substrate, a ceramic substrate, a polymer plasticized substrate, and a composite material substrate.

6. The cathode flow field board according to claim 1, wherein the current collector sheet is selected one from a stainless steel (SUS316) sheet, a gold foil, a titanium metal, a graphite material, a carbon metal compound material, a metal alloy sheet, and a polymer conductive sheet with low resistance.

7. The cathode flow field board according to claim 1, wherein the cathode flow field board is a one-sided cathode flow field board.

8. The cathode flow field board according to claim 1, wherein the cathode flow field board is a two-sided cathode flow field board.

9. The cathode flow field board according to claim 1, further comprises: a printed circuitry, and the printed circuitry is electrically connected to the current collector sheets.

10. The cathode flow field board according to claim 1, further comprises at least one electric component, which are configured on the substrate.

11. The cathode flow field board according to claim 10, wherein the electric components comprise: a temperature sensor, a density sensor, a liquid level sensor, a heating device, and a cooling device.

12. The cathode flow field board according to claim 1, wherein the first hollow area and the second hollow area are configured on the same side of the substrate.

13. The cathode flow field board according to claim 1, wherein the outlet channel structure is composed of a plurality of parallel slots, and the slots are connected to the slot bodies.
